(19) United States
(12) Patent Application Publication
(10) Pub. No.: US 2007/0086833 A1
(43) Pub. Date: Apr. 19, 2007

(54) Dispenser for personal care composition

(76) Inventor: Paul Gurrisi, Kingston, NH (US)

Correspondence Address: FISH & RICHARDSON P.C., P.O. BOX 1022, MINNEAPOLIS, MN, 55440-1022, US

(21) Appl. No.: 11/254,139

(22) Filed: Oct. 19, 2005

(51) Int. Cl. B05C 11/00; B43M 11/06; B43K 5/06

(52) U.S. Cl. 401/266; 401/263; 401/175

(57) ABSTRACT

An apparatus for dispensing a personal care composition to the skin includes a container with a reservoir containing the composition. The apparatus has an application end having fibers, with free ends, that provide an application surface.

### TECHNICAL FIELD

This invention relates to an apparatus for dispensing a personal care composition.

### BACKGROUND

There are various types of antiperspirant and deodorant compositions. One type of antiperspirant composition is liquid and includes an antiperspirant salt dissolved in a hydrophilic vehicle such as water or ethanol. Such liquid antiperspirant compositions can be dispensed, for example, using conventional roll-on applicators.

### SUMMARY

In general, the invention relates to an apparatus for dispensing a personal care composition such as an antiperspirant or deodorant composition. The apparatus has an application end including fibers that provide an application surface for applying the composition to the skin. The apparatus is particularly suitable for use with liquid compositions having a relatively low viscosity, for example, less than 1000 cp, 200 cp, or even less than 50 cp.

In one embodiment, the apparatus includes a fiber support at the application end of a container and the fibers extend from the fiber support. The fiber support includes one or more openings that allow the composition within the container to flow to the outer surface of the support and the fibers.

In another embodiment, the apparatus includes a container having a generally hollow reservoir including the composition.

In another embodiment, the apparatus includes a transport having a piston within the container. A reservoir is located between the piston and the application end, and the piston is adapted to move towards the application end to discharge the composition from the reservoir.

The invention also features using the apparatus for delivering a personal care composition to the skin.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective exploded view of a dispenser for a personal care composition; and

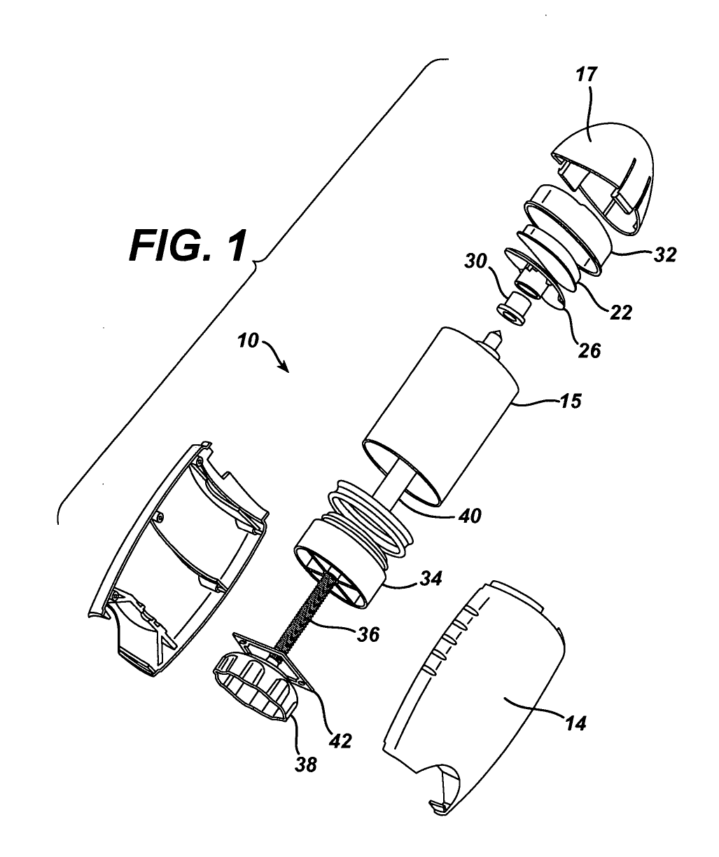

FIG. 2 is a front sectional view of the dispenser in FIG. 1, without the cap.

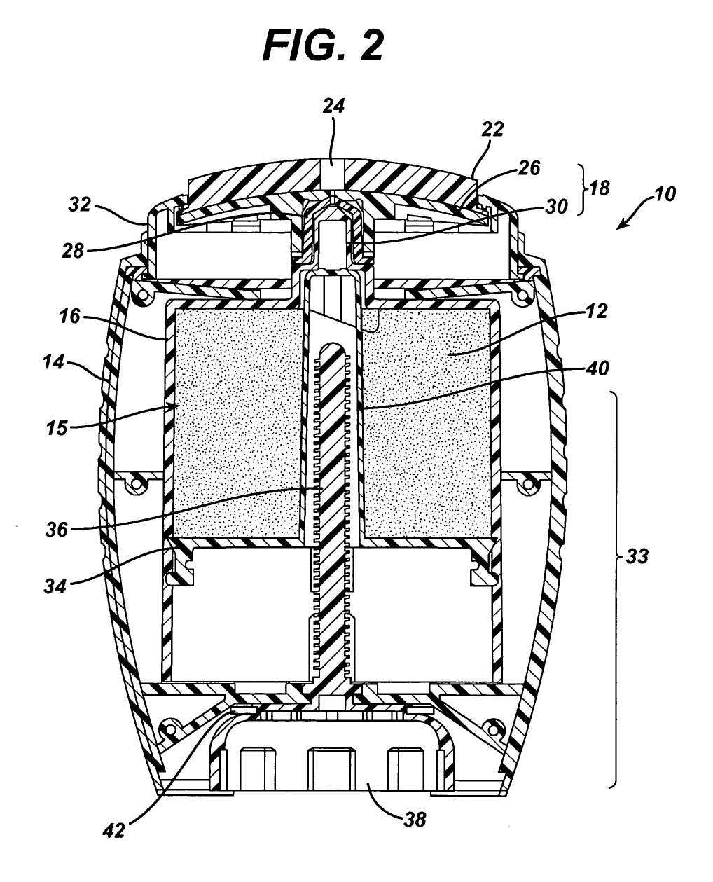

### DETAILED DESCRIPTION

Referring to the Figures, dispenser 10 includes an antiperspirant or deodorant composition 12 in the form of a liquid, cream, paste, or gel. In a preferred embodiment, the composition is a liquid having a viscosity of less than 1,000 cp, and preferably less than 200 cp or 50 cp. Viscosity is measured at 21° C. using a Brookfield Model viscometer with spindle # 3.

Dispenser 10 has an outer plastic shell 14, a reservoir 15 defined in part by plastic walls 16 and containing composition 12, and locking cap 17. Plastic walls 16 can be made of any suitable plastic that does not deteriorate over time when exposed to an antiperspirant or deodorant composition.

Dispenser 10 includes an applicator end 18 sized and shaped for contact with an underarm. Applicator end 18 includes pile 22 mounted in a plastic support 26 having central hole 24. Plastic support 26 can be, for example, hard plastic that will not deteriorate over time when exposed to an antiperspirant or deodorant composition.

Pile 22 includes groups of fibers. The fibers may be made, for example, of nylon, polyester or other suitable plastic that will not deteriorate over time when exposed to an antiperspirant or deodorant composition. The fibers can have, for example, length between 1/32″ and ¾″, or between ⅛″ and ½″ (e.g., ⅛″). The fibers in a group or in different groups can have the same or different lengths. Length is measured from the surface of plastic support 26 to the end of the fiber. Each group of fiber may include, for example, between 1 and 1000 fibers or 20 and 100 fibers. Each group may include the same or different number of fibers. In alternative embodiments the fibers are not arranged in groups but instead are distributed evenly, or unevenly, across the surface of support 26.

Dispenser 10 also includes a soft plastic cup 28 that fits over neck 30 of reservoir 15 and is received centrally in plastic member 26. Soft plastic cup 28 forms a seal between the plastic pile support 26 and neck 30, while providing the spring force to lift plastic pile support 26 and open the ports to communicate the liquid to pile 22. Plastic support 26, cup 28, and neck 30 include openings that communicate with each other and opening 24 and ultimately allow delivery of antiperspirant or deodorant composition 12 from container 16 to the surface of the plastic support. A plastic mounting element 32 retains the pile material and plastic member 26 to shell 14.

Dispenser 10 also includes a transport mechanism 33. Transport mechanism 33 includes a piston 34 threadedly engaged with a shaft 36. Transport mechanism 33 also includes a turnbuckle 38 which, when turned, advances piston 34 upward on shaft 36. An elastomeric sheath 40 extends from piston 34 and covers shaft 36. Sheath 40 creates a sealed environment to prevent the leakage of the fluid between the container 16 and the piston 34 or between the threaded shaft 36 and the piston 34. An anti-rotation clip 42 allows turnbuckle 38 to be turned a fixed amount while providing an audible click to provide an auditory feedback that indicates the predetermined amount of composition 12 delivered to the surface of pile 22.

Suitable antiperspirant and deodorant compositions for use in dispenser 10 are known in the art.

Preferred antiperspirant compositions include an antiperspirant salt dissolved in a hydrophilic vehicle. Preferred antiperspirant compositions may include, by weight, between about 10% and 70%, and more preferably from about 15% to about 60%, of the vehicle; and between about 8% and about 25% (USP) of the antiperspirant salt. “Hydrophilic vehicle”, as used herein, includes monohydric alcohols including 2-6 carbon atoms such as ethanol, polyhydric alcohols having 3-6 carbon atoms and 2-6 hydroxyl groups such as propylene glycol, and water not bound to the antiperspirant salt.

Preferred antiperspirant salts include aluminum, zirconium, and aluminum/zirconium salts.

Preferred aluminum salts are those having the general formula Al₂ (OH)₆₋ₐXₐ wherein X is Cl, Br, I or NO₃, and a is about 0.3 to about 4, preferably about 1 to 2, such that the Al to X mole ratio is about 1:1 to 2.1:1. These salts generally have some water of hydration associated with them, typically on the order of 1 to 6 moles per mole of salt. Most preferably, the aluminum salt is aluminum chlorohydrate (i.e. X is Cl) and a is about 1, such that the aluminum to chlorine mole ratio is about 1.9:1 to 2.1:1.

Preferred aluminum-zirconium salts are mixtures or complexes of the above-described aluminum salts with zirconium salts of the formula ZrO(OH)_{2-pb}Y_{b} wherein Y is Cl, Br, I, NO₃, or SO₄, b is about 0.8 to 2, and p is the valence of Y. The zirconium salts also generally have some water of hydration associated with them, typically on the order of 1 to 7 moles per mole of salt. Preferably the zirconium salt is zirconyl hydroxychloride of the formula ZrO(OH)_{2-b}Cl_{b} wherein b is about 1 to 2, preferably about 1.2 to about 1.9. The preferred aluminum-zirconium salts have an Al:Zr ratio of about 1.7 to about 12.5, most preferably about 2 to about 10, and a metal:X+Y ratio of about 0.73 to about 2.1, preferably about 0.9 to 1.5. A preferred salt is aluminum-zirconium chlorohydrate (i.e. X and Y are Cl), which has an Al:Zr ratio of about 2 to about 10 and a metal:Cl ratio of about 0.9 to about 2.1. Thus, the term aluminum-zirconium chlorohydrate is intended to include the tri-, tetra-, penta- and octa-chlorohydrate forms. The aluminum-zirconium salt complexes may also contain a neutral amino acid, preferably glycine, typically with a Gly:Zr ratio of about 1:1 to 4:1.

Examples of preferred antiperspirant salts include the aluminum and aluminum-zirconium enhanced efficacy antiperspirant salts described in U.S. Pat. No. 5,330,751 and the calcium enhanced aluminum-zirconium chlorohydrate salts described in U.S. Pat. No. 6,942,850 and U.S. Pat. No. 6,245,325, which also is incorporated by reference herein.

Deodorant compositions include a vehicle and one or more deodorant active ingredients. Preferred deodorant compositions may include, by weight, between about 10% and about 98%, and more preferably from about 15% to about 90%, of the vehicle; and between about 0.01% and about 10%, more preferably between about 0.1% to 6%, of the deodorant active ingredient.

Preferred vehicles for deodorant compositions include those described above for antiperspirant compositions.

Suitable deodorant active ingredients inhibit, suppress, mask or neutralize malodor. These may include (1) antimicrobial or bactericidal agents which kill the bacteria responsible for malodor production, (2) agents which inhibit or suppress or interfere with the bacterial enzymatic pathway that produces malodor, and (3) agents which mask or absorb or neutralize malodor. Fragrances are not considered deodorant active ingredients within the meaning of this application. Examples of deodorant actives include triclosan, triclocarban, usnic acid salts, zinc phenolsulfonate, b-chloro-D-alanine, D-cycloserine, aminooxyacetic acid, cyclodextrin, sodium bicarbonate. Antiperspirant salts may also function as deodorant actives.

The antiperspirant and deodorant compositions may also include other conventional cosmetic ingredients that provide desired properties. These ingredients include surfactants, fragrances, encapsulated fragrances, colorants, emollients, or a combination.

The viscosity of the antiperspirant or deodorant may be increased if desired by including a thickening agent. Any thickening agent may be used provided it is compatible with, for example, aqueous alcoholic solutions. Particularly suitable thickening agents include the hydroxyalkyl celluloses, such as hydroxyethyl cellulose and hydroxypropyl cellulose. Other thickening agents also may be used such as carboxypolymethylene, carboxy vinyl polymer (e.g., Carbopol), sodium carboxymethyl cellulose, starches, gums, pectins, polyacrylates, etc. If included in the composition, the thickening agent will be present in an amount to provide the desired viscosity, typically about 0.01% to about 5% by weight, more typically about 0.05% to about 2%.

### EXAMPLE

An antiperspirant composition was made having the formulations as set out in the table below.

Weight Percent

| Ingredient | Ex. 1 | Ex. 2 | Ex. 3 | Ex. 4 |
|---|---|---|---|---|
| Water (and) Aluminum | 50.0 | 76.0 | 60.0 | 76.0 |
| Zirconium Tetrachlorohydrex | | | | |
| Gly (28-29%) (and) CaCl₂ | | | | |
| (1.63%) ¹ | | | | |
| Ethanol | 48.6 | 19.0 | 35.0 | 20.0 |
| Hydroxypropyl cellulose | 0.4 | | | |
| Hydroxyethyl cellulose | | 0.4 | | 0.2 |
| C11-15 Pareth-12 (and) | | 3.0 | | 3.0 |
| PEG-40 Hydrog. Castor Oil | | | | |
| Butylene carbonate | | | 3.0 | |
| PPG-5-Ceteth-20 | | | 1.0 | |
| Fragrance | 1.0 | 1.6 | 1.0 | 0.8 |

¹ Prepared according to U.S. Pat. No. 6,942,850; salt includes about 3.4% glycine and about 1.8% Ca.

To use dispenser 10, cap 17 is removed and turnbuckle 38 turned. A metered amount of composition 12 is provided from reservoir 15 through central hole 24 to the base of the fibers in 22. The composition flows along the pile at the base of its fibers. Capillary action draws the composition onto the fibers and, preferably, provides sufficient force to hold the metered amount of composition on the fibers even when the dispenser is inverted. The composition can be applied to the underarm by stroking the fibers along the skin.

After applying composition to an underarm, there may be a residual amount of composition remaining on the fibers and plastic support. Locking cap 17 is reapplied to the dispenser and preferably seals the application surface to minimize evaporation of the vehicle.

The quantity of composition provided to pile 22 by advancing turnbuckle 38 approximates the quantity of composition typically applied to one underarm during use. The density, length, etc. of the fibers can be adjusted to hold a desired quantity of compositions during use.

Other embodiments are within the claims. For example, although plastic support 26 includes one central hole 24 in alternative embodiments the plastic support can have two, three, or more openings to enhance distribution of the composition across the surface of the plastic support to the of fibers. Moreover, the applicator can be used to apply other personal care compositions to the skin. Examples of other compositions include body washes, aftershaves, or skin softeners.

The dispenser can include other mechanisms for dispensing the personal care composition. The reservoir can be, for example, a collapsible bag that is pressurized in a manner analogous to known dispensers of shaving foams or creams. Alternatively, the dispenser can be sufficiently flexible so that, when a user squeezes the dispenser, pressure on the reservoir causes the composition to be dispersed.

What is claimed is:

1. An apparatus for dispensing a personal care composition to skin, comprising
a container comprising a reservoir including a personal care composition suitable for application to skin, the container having an application end,
a fiber support, having an outer surface, at the application end of the container,
fibers having free ends extending from the fiber support to provide an application surface, and
an opening through the fiber support to allow the composition to pass to the outer surface of the fiber support.

2. An apparatus for dispensing a personal care composition to skin, comprising
a container comprising a generally hollow reservoir including a personal care composition suitable for application to skin, the container having an application end, and
fibers extending from the application end and providing an application surface for contacting skin.

3. The apparatus of claims 1 or 2, wherein the fibers are arranged in groups.

4. The apparatus of claim 3, wherein the apparatus includes between 10 and 1000 groups of said fibers.

5. The apparatus of claim 3, wherein each said group includes between 1 and 1000 fibers.

6. The apparatus of claims 1 or 2, wherein the composition has a viscosity of less than 1,000 cp.

7. The apparatus of claims 1 or 2, wherein the composition has a viscosity of less than 200 cp.

8. The apparatus of claims 1 or 2, wherein the composition is an antiperspirant comprising including a vehicle and an antiperspirant salt.

9. The apparatus of claim 8, wherein the vehicle comprises water and/or ethanol.

10. The apparatus of claims 1 or 2, wherein the composition is a deodorant composition including a vehicle and a deodorant active ingredient.

11. The apparatus of claims 1 or 2, wherein the fibers have an average exposed length between 1/32 and ½.

12. The apparatus of claims 1 or 2, wherein the fibers comprise nylon and/or polyester.

13. The apparatus of claims 1 or 2, wherein the apparatus further comprises a locking cap that covers the fibers.

14. The apparatus of claim 1, wherein the fiber support is a hard plastic.

15. The apparatus of claim 1, wherein the fiber support includes only one said opening.

16. The apparatus of claim 1, wherein the composition after passing through the opening flows along the outer surface of the fiber support, contacts the fibers, and then moves along each fiber by capillary action.

17. The apparatus of claims 1 or 2, wherein the apparatus further comprises a transport comprising a piston situated below the fiber support within the container, the reservoir being located between the piston and the fiber support, the piston being adapted to move toward the applicator surface.

18. The apparatus of claims 17, wherein the transport further comprises a turnbuckle coupled to a threaded shaft which is threadedly engaged to said piston, wherein rotation of the buckle causes rotation of the threaded shaft which causes the piston to advance to deliver a metered amount of the composition from the reservoir.
